(19) United States
(12) Patent Application Publication
(10) Pub. No.: US 2024/0171944 A1
(43) Pub. Date: May 23, 2024

(54) METHODS FOR TRACKING MOVING OBJECTS USING MOBILE LOCATION DEVICES AND RELATED SYSTEMS AND COMPUTER PROGRAM PRODUCTS

(71) Applicant: Wiser Systems, Inc., Raleigh, NC (US)

(72) Inventors: Seth Edward-Austin Hollar, Raleigh, NC (US); Elizabeth Hollar, Raleigh, NC (US)

(21) Appl. No.: 18/057,843

(22) Filed: Nov. 22, 2022

(51) Int. Cl. H04W 4/029; H01M 10/46; H04W 4/30

(52) U.S. Cl. CPC H04W 4/029; H01M 10/46; H04W 4/30; H01M 2220/30

(57) ABSTRACT

Systems for tracking movable assets in outdoor or underground environments are provided. The system includes at least one stationary location device affixed to an element of the environment; at least one mobile location device attached to a corresponding moveable asset positioned in the environment and a plurality of tagged assets in the environment. The plurality of tagged assets communicate with the at least one stationary location device and the at least one mobile location device. Information provided by the at least one mobile location device and the at least one stationary device is used to create a trackable area in the environment that enables location of the plurality of tagged assets within the trackable area.

### FIELD

The present inventive concept relates to location systems and, more particularly, to location systems mounted to moving objects.

### BACKGROUND

In closed indoor settings, a number of real-time tracking location systems (RTLS) have enabled users to track assets with great accuracy. Ultra-wideband (UWB), specifically, is known for its accuracy and ability to timestamp radio frequency (RF) signals. However, most of these systems require stationary location devices at known distances from each other to communicate with trackable objects to find their location. For larger and/or outdoor or underground applications, however, many of these solutions can be challenging or overly expensive to execute.

For example, in yard-management settings, users sometimes want to track objects that are mobile themselves. For example, these moving objects may include buses, trains, garbage trucks, rental car fleets, shipping trucks, semitrucks at a port, boats and the like. In many cases the settings where these moving object are located or stored are large and outdoors. Affixing stationary location devices in the large, outdoor areas may be costly because it likely necessitates building poles or, in some instances, may not even be possible, for example, on the water to track boats at a dock.

### SUMMARY

Some embodiments of the present inventive concept provide systems for tracking movable assets in outdoor or underground environments. The system includes at least one stationary location device affixed to an element of the environment; at least one mobile location device attached to a corresponding moveable asset positioned in the environment and a plurality of tagged assets in the environment. The plurality of tagged assets communicate with the at least one stationary location device and the at least one mobile location device. Information provided by the at least one mobile location device and the at least one stationary device is used to create a trackable area in the environment that enables location of the plurality of tagged assets within the trackable area.

Related methods, systems and computer program products are also provided.

### BRIEF DESCRIPTION OF THE DRAWINGS

FIG. 1 is a diagram illustrating a system including location devices affixed to mobile vehicles to track objects in accordance with some embodiments of the present inventive concept.

FIG. 2 is a diagram illustrating a system including a single mobile location device locating an asset while it is in motion in accordance with some embodiments of the present inventive concept.

FIG. 3 is a diagram illustrating a location device with potential adaptions to operate effectively when mounted to a mobile vehicle in accordance with some embodiments of the present inventive concept.

FIG. 4 is a diagram illustrating how a location device is provided power in accordance with some embodiments of the present inventive concept.

FIG. 5 is a diagram illustrating how to power the location device when the vehicle is on in accordance with some embodiments of the present inventive concept.

FIG. 6 is a diagram illustrating powering a location device on vehicles that lack an electrical power system, such as, bicycles or simple boats in accordance with some embodiments of the present inventive concept.

FIG. 7 is a diagram illustrating recharging a device battery when in motion in accordance with some embodiments of the present inventive concept.

FIG. 8 is a diagram illustrating sensors for a mobile location device in accordance with some embodiments of the present inventive concept.

FIG. 9 is a diagram illustrating a system including the addition of inertial measurement unit (IMU) sensor(s) to improve the functionality of a location device affixed to a mobile vehicle in accordance with some embodiments of the present inventive concept.

FIG. 10 is a diagram illustrating use of IMUs in combination with a single location device to determine location accurately in accordance with some embodiments of the present inventive concept.

FIG. 11 is a diagram illustrating the use of combined camera-UWB location devices to assist the system with determining locations in accordance with some embodiments of the present inventive concept.

FIG. 12 is a diagram illustrating use of combined camera-UWB location devices on a mobile location device to assist the system with determining location in accordance with some embodiments of the present inventive concept.

FIG. 13 is a diagram illustrating a system utilizing UWB combined with GPS for location tracking in accordance with some embodiments of the present inventive concept.

FIG. 14 is a diagram illustrating a system where mobile location devices combine with GPS and generate absolute location data over a large area in accordance with some embodiments of the present inventive concept.

FIG. 15 a diagram illustrating a system where mobile location devices combine with GPS to generate absolute location data over a large area by focusing on smaller regions in accordance with some embodiments of the present inventive concept.

FIG. 16 is a diagram illustrating the use of a drone outfitted with a mobile location device to locate tagged assets within an area in accordance with some embodiments of the present inventive concept.

FIG. 17 is a diagram illustrating how a drone with an affixed location device can act as multiple location devices by capturing location data from multiple positions within an area in accordance with some embodiments of the present inventive concept.

FIG. 18 is a diagram illustrating a mobile location device system in a 3-D multi-floor environment in accordance with some embodiments of the present inventive concept.

FIG. 19 is a diagram illustrating a system including a dynamic mesh area where a number of outside vehicles can be integrated into a mesh of stationary and/or local mobile location devices to allow for accurate, precise location of needed assets in accordance with some embodiments of the present inventive concept.

FIG. 20 is a diagram illustrating a two Mesh Location Calculation in accordance with some embodiments of the present inventive concept.

FIG. 21 is a block diagram illustrating a data processing system that can be used in accordance with some embodiments of the present inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

As discussed above, in closed indoor settings, stationary location devices at known distances from each other are used to communicate with trackable objects to find locations of the trackable objects. However, for large and/or outdoor or underground applications environments, it may be more difficult or even impossible to track moving objects. Accordingly, some embodiments of the present inventive concept track moving objects in large outdoor environments by attaching location devices to moveable objects, various embodiments of which will be discussed further herein.

Although embodiments and examples discussed herein incorporate ultra-wideband (UWB) as part of their radio frequency (RF) location solution, embodiments of the present inventive concept are not limited to this configuration. For example, embodiments of the present inventive concept may be applied to any technology capable of deriving raw location data between two devices including but not limited to Wi-Fi, photo transmitters and photodetectors, LoRa, Bluetooth, and any other radio frequency technologies whose messages can be received with distinct arrival times, and the like.

It will also be understood that while many of the examples described herein use vehicles as the “objects in motion” on/in which mobile location devices and tags are attached, embodiments of the present inventive concept may also be applied generally to any objects in motion, such as: people, animals, packages, shipped items, pallets, golf cars, forklifts, carts, and the like.

As used herein, a “camera” refers to any visually sensing device including optical cameras, LiDAR, motion sensors, or other visual sensing device. A “mobile location device” refers to, in some embodiments, a mobile UWB enabled device which can be used to track other location devices and tags. A “stationary location device” refers to a stationary UWB enabled device which can be used to track other location devices and tags. As discussed above, the mobile and stationary location devices are not limited to UWB. A “tag” refers to a UWB enabled device which can be tracked by location devices. A “mesh” refers to a system of location devices that together can be used to determine position of tags and location devices within a defined area. A “server” refers to a computational device where data is stored. A “data analysis tool” refers to software that makes computations based on data.

Various embodiments of the present inventive concept will be discussed. For larger objects, such as trucks, large equipment, boats and the like, one solution is to affix the location devices to the objects that are being tracked. For example, in a truck yard, location devices may be mounted directly on several trucks rather than on polls. The challenge is that when a location device-mounted truck moves, the location devices may not work as well together. Some of these challenges are discussed, for example, in U.S. patent application Ser. No. 17/155,406 (the '406 patent) entitled Methods, Systems and Computer Program Products for Determining Location of Tags in an Environment Using Mobile Antennas, the content of which is incorporated herein by reference as if set forth in its entirety. As discussed therein, one or more mobile location devices can communicate with tags or other location devices to determine location. In mobile and stationary location device systems, multiple location devices can work together to create a “mesh” or trackable area that can be used to locate tagged assets within the area reachable by the mobile and/or stationary location devices.

By extending the ideas from the 406 patent, the trucks with mounted location devices could create a dynamic, mobile mesh which can locate tagged assets or location device-mounted trucks even as the location devices move. The user determines what percentage of trucks require a mobile location device to maintain the integrity of the mesh to be able to track all trucks across the yard. Once the percentage is established and the required number of trucks are outfitted with location devices, the user would have a trackable group of trucks without requiring large amounts of infrastructure including poles for affixing location devices, wiring with which to communicate with or power the location devices.

Location device mounted vehicles are not without challenges. For example, beyond a mounting location, location devices require power and a way to communicate with a database or other information systems for successful operation of the system. Power is required to send and receive signals among location devices and trackable nodes (i.e., tags) in the system, and to transmit location information to a data processing unit that will collect and analyze the location information. While location devices can operate on batteries, regularly replacing batteries can become cumbersome for the user so a method to supply power to location devices to reduce drawing on batteries can extend times between battery replacement or recharging. Fortunately, most vehicles do have an electrical power system that can be tapped into especially when a vehicle is turned on. For example, the electrical power of a location device can be wired into the electrical power system of most cars, buses, trucks, and other vehicles.

The location device could also interface with the data interface to the vehicle diagnostic system. Key information could be read and used for location determination including but not limited to vehicle speed, steering wheel position, even global positioning system (GPS) information. For example, many cars and trucks use the OBD-II port which provides vehicle speed, mileage, emissions, and the like.

When the vehicle is turned off, however, another solution may be needed. For vehicles that have accessible power from its electrical power system, a rechargeable battery could be used. It could be charged whenever the vehicle is turned on, and then when the vehicle is turned off the location device can run off the charged battery. Alternatively, a larger vehicle could be outfitted with, for example, solar cells, that the location device can utilize for power if the vehicle is turned off during the day. Without a properly sized battery, however, the solar cell solution may be insufficient at night or on cloudy days.

For location devices mounted to vehicles, the location devices may also need a way to communicate collected location information to a server used to compute location of vehicles. Clearly, vehicles do not have a wired connection to a server, so a wireless means can be used to transmit data to and from the mobile location device. A variety of wireless communication formats, such as Wi-Fi, Bluetooth, LoRa, and the like, can be used to transmit this information to the data repository. Furthermore, data can be transferred through the UWB network itself to a stationary location device which in turn can communicate to the server. Transferring data may require the location device to be in the “on” powered state more of the time. For battery powered units, or units that have limited power availability, the power system architecture of the mesh needs to be considered. As noted, alternative power sources discussed above may become even more important for the successful operation of the tracking system.

In addition, for vehicles that lack an electrical power system or are rarely turned on, such as, simple boats, bicycles, animals, livestock, and the like, the use of a solar cell with a rechargeable battery could provide sufficient power for the successful operation of the mesh.

When a vehicle with an affixed mobile location device is in motion, the mesh may be dynamically changing and may recalculate the position of the mobile location device as it moves with the vehicle. At times it may lose contact with the other location devices as the mesh recalibrates. A variety of solutions exist to determine location during those periods and maintain the accuracy of the mesh while vehicles are in motion.

For example, inertial measurement units (IMUs) can be integrated into the location devices to determine when a location device-mounted vehicle is in motion. IMUs can determine acceleration, angular velocity, and sometimes magnetic true North. With this information, paired with previous location data points collected by the location devices, the system can extrapolate where the vehicle is moving. For example, the system can apply a dead reckoning algorithm to the data generated from the IMUs to have a best guess of its location and trajectory at any point in time. A dead reckoning algorithm calculates current position of some moving object by using a previously determined position, or fix, and then incorporates estimates of speed, heading direction, and course over elapsed time. Once the vehicle-mounted location device reconnects to the mesh, the estimate can be replaced by a true, relative location within the mesh. As long as the time span during reconnection is short, the system is able to offer sufficient accuracy on vehicle location. Furthermore, IMUs can work in conjunction with UWB data where the two data sets can be fused together. This may enhance the location calculation of the location devices and tags. It will be understood that the system is not limited to the use of IMUs.

Some other augmentations that may improve system accuracy may include pairing with stationary location devices, location device-mounted drones, or cameras. There may be concern that the mesh could become unstable due to insufficient power in situations where the vehicles remain dormant for long periods of time such as during the holidays. Alternatively, in situations where there are a lack of available mobile location devices affixed to vehicles, such as, during the day when a majority of vehicles are out, the mesh may also be unable to collect raw location data to calculate locations of the vehicle. To address these circumstances, several solutions may be implemented to enhance the accuracy of the system.

For example, a small number of fixed location devices could be placed on surrounding walls or fixed areas to provide some stability to the mesh. While the accuracy may be lower, they should be adequate to meet the tracking needs at that time. In the first scenario, especially at night or during the holidays, the vehicles are rarely moving. In the second scenario when most of the vehicles are out of the yard due to use, there are a small number of vehicles to track.

During periods of low use or limited availability of location devices, a second solution may be to mount a flying drone or small autonomous vehicle with a location device that could sweep a large area to maintain the mesh. By making multiple passes the drone or autonomous vehicle could take location measurements from a variety of locations and thereby generate an accurate location map of all vehicles within the mesh.

Finally, cameras could be paired with the UWB system to augment its accuracy at both low use and active periods. During low occupancy of a yard, cameras are able to see far across the yard to identify vehicles. If a vehicle starts to move, this can alert the system to verify movement and prioritize tracking it. Furthermore, the camera generated data can assist with dead reckoning calculations for vehicle-mounted location devices that may be temporarily disconnected from the system. Finally, cameras may also have the benefit of identifying vehicles using visual cues such as license plate numbers by using optical character recognition. At night, when cameras are not as useful, LiDAR or motion cameras could be used to look for movement within the yard. It will be understood that cameras cannot easily solve these tracking problems in a yard independently because they are often limited by line-of-sight which can be hampered when the yard is close to capacity. Cameras also lack depth perception when viewing a group of vehicles from the side.

By adding LiDAR or camera based sensors to a UWB mesh, tracking to areas could be expanded where UWB meshes may be out of reach. For example, it may not be possible to add poles in the middle of large parking areas to support a mesh of UWB location devices there. However, LiDAR and cameras can identify vehicles at much larger distance than UWB can reach and support these types of meshes. U.S. patent application Ser. No. 17/215,888 entitled Integrated Camera and Ultra-Wideband Location Devices and Related Systems, the disclosure of which is incorporated herein by reference as if set forth in its entirety, discusses an area where both the camera/LiDAR and the UWB systems identifies vehicles, and the system pairs the visual attributes of the vehicle to the tracked tag. In these embodiments, once pairing occurs, the vehicle is visually tracked within the area without the need of covering the area with UWB location devices. For situations like buses that may all look alike, however, momentarily losing a vehicle may make it difficult to reacquire its location later on. The use of inertial measurement units may aid in tracking visually as has been done with UWB, however. In addition to color, shape, patterns, etc., visual attributes could also include letters, numbers, and various other text and symbols in which optical character recognition (OCR) could be applied.

In addition to tying into the power system of the vehicle, additional methods of power could include, for example, solar cells, or even vibratory energy harvesting transducers. Solar cells are sized correctly for the location, and one would need to determine whether the vehicles were all outdoors, or if they were indoors thus hampering the full charging capability of the system. Furthermore, solar cells would need to be paired with appropriately sized batteries to run the tag/location device hardware for worst case darkness scenarios.

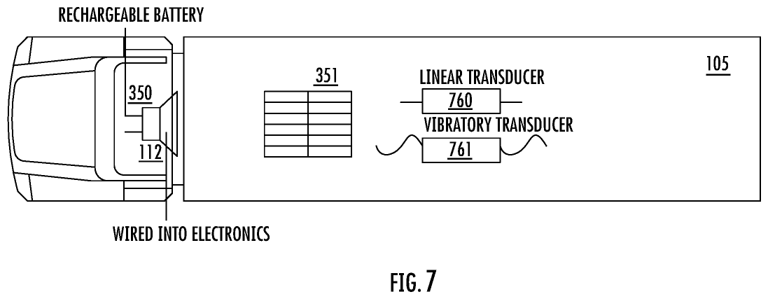

Motion transducers can also serve as energy harvesters. In these embodiments, a vibratory or linear transducer (FIG. 7) could be used. A linear transducer is placed length-wise to the vehicle such that whenever the vehicle accelerated or braked, the associated motion is converted to electrical energy to power the location device and charge a battery. Alternatively, a vibratory transducer could also be used. In these embodiments, when the vehicle is turned on, the vibrations from the vehicle's engine could produce small amounts of energy that could be captured and converted to electricity. The energy harvesters are sized correctly and placed strategically on the vehicle to capture sufficient amount of power for the location devices. For example, vibration transducers may need to be located near the engine of the vehicle to maximize energy capture. Linear transducers are sized large enough to capture the bursts of energy created with the vehicle accelerated or braked.

The UWB-based system could also be paired with GPS to track vehicles over an area that is too large to economically cover with a UWB system or which regularly move between two or more distant locations.

For extremely large areas where tracking may be necessary, such as oil refineries, mining areas, farms, and the like, there may be a need to track moving vehicles and related personnel or equipment but only where they currently are. In these embodiments, the mobile location devices can work together to create a mesh that defines the relative location of all tagged items within the mesh. One or more of the system's location devices can also be paired with a GPS sensor. Once the accurate GPS location of one or more location devices is known, the mesh converts the relative locations to absolute locations, and the absolute location of all assets within the mesh is known. In this way, the user can know the absolute location of all assets over a broad area at any location within an extremely large site. There would need to be some means of communicating that information to the server, for example using cellular or other wireless means.

In some embodiments, a yard area may involve multiple floors (FIG. 18), such as taxis or rental cars in a parking garage. In these embodiments, the system must have some intelligence to accurately assess which floor the vehicle is on. By augmenting the system with additional location-based decision logic, as discussed in, for example, U.S. patent Ser. No. 17/161,122 entitled Real Time Tracking Systems in Three Dimensions in Multi-Story Structures and Related Methods and Computer Program Products, the content of which is hereby incorporated herein by reference, the system can reduce false floor changes in a multi-floor mesh. For example, the system may only recognize that a vehicle has moved to another floor if it has gone through a floor ramp or exit area of the parking garage. This scenario or z-axis tracking is straightforward since the tags and mobile location devices will for the most part have the same height relative to each floor, and as such the resolution for detecting Z height is the floor to floor height.

In some dynamic locations, such as ports, local vehicles, such as forklifts, trucks, and the like may work exclusively at the location while other visiting vehicles, such as, semi-trucks, ships, and even containers, will come in and out of the area. If the visiting vehicles are outfitted with mobile location devices that can reconnect to the local port mesh, the system can track where all the various vehicles and key assets are located. This would be extremely valuable for outside vehicles to precisely identify the location of containers and cargo that need to be picked up. It would also be very helpful for port managers to assess the movement of cargo through the port area.

It will be understood that many algorithms may be used to track in the UWB systems. For example, any combination of time of flight (ToF), time difference of arrival (TDOA), and angle of arrival (AoA) could be used without departing from the scope of the present inventive concept. Furthermore, the addition of IMU, Camera, and LiDAR data could further augment tracking. Algorithms used for tracking are discussed in, for example, U.S. Pat. No. 10,462,762 entitled Methods for synchronizing multiple devices and determining location based on the synchronized devices and U.S. patent application Ser. No. 17/155,406 entitled Methods, Systems and Computer Program Products for Determining Location of Tags, the disclosures of which are hereby incorporated herein by reference.

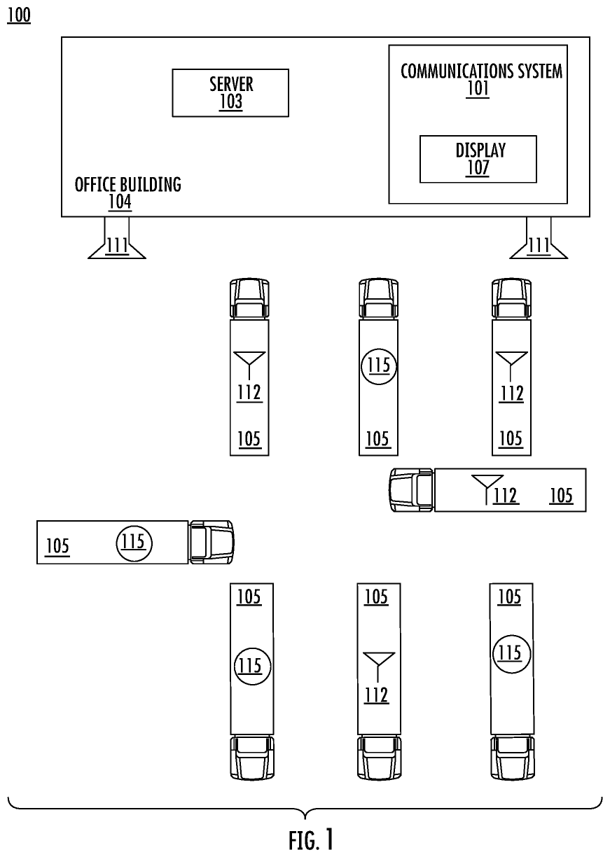

Details of various of the embodiments discussed above will now be discussed with respect to FIGS. 1 through 21. Referring first to FIG. 1, a system 100 for tracking objects including mobile assets, for example, vehicles, having location devices 112 affixed thereto will be discussed. As illustrated in FIG. 1, the system 100 includes a plurality of assets, vehicles/trucks 105, a plurality of antennas, both stationary 111 and mobile 112, in communication with a communications system 101 including a sever 103, a communications device 101 having a display 107 associated therewith. As illustrated, the stationary antennas 111 are positioned on existing infrastructure, for example, the exterior walls of the office building 104. The communications system 101 may include a data processing system 2100 (FIG. 21) or may be associated with a data processing system 2100. Although the vehicles 105 are depicted as trucks, embodiments of the present inventive concept are not limited to this configuration. The system 100 of FIG. 1 is provided as an example only and, thus, embodiments of the present inventive concept should not be limited thereto.

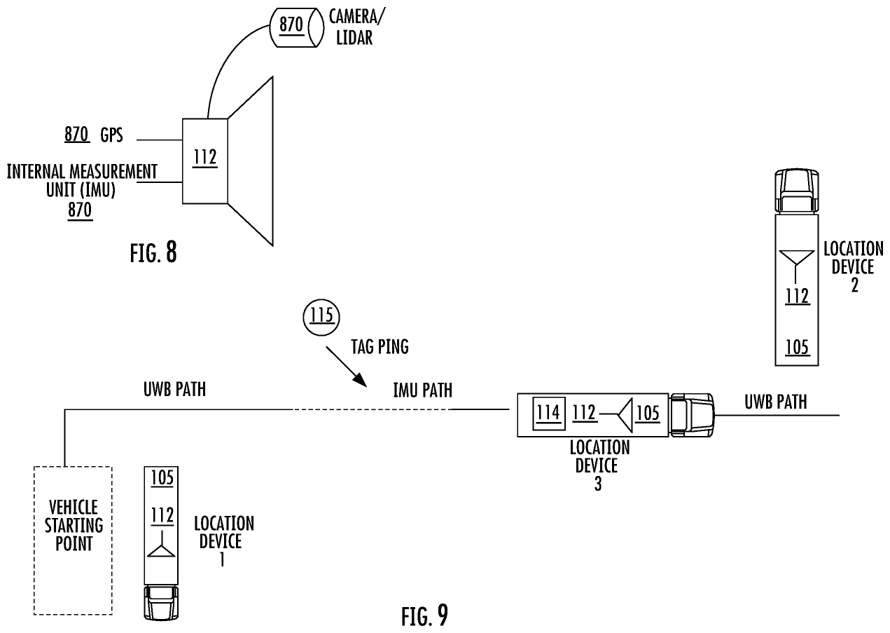

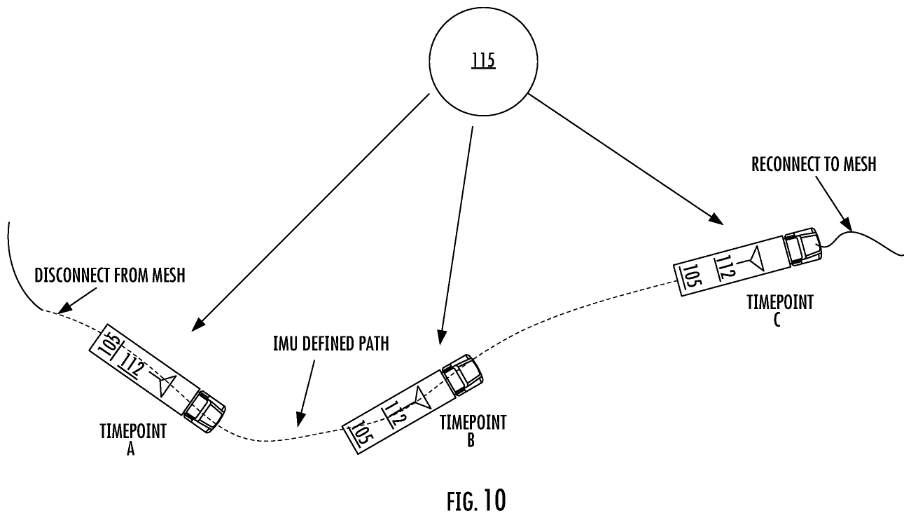

Some embodiments of the present inventive concept adapt UWB based RTLS tracking location devices 112 for use on a mobile object, for example, the vehicles 105 shown in FIG. 1. The tracking solution can be further adapted using UWB location devices affixed to stationary mounts (111), camera sensors (FIG. 8), IMU sensors (FIG. 9), GPS (FIG. 13), and other sensor technologies to enhance the solution's tracking effectiveness. For use on mobile vehicles and objects, powering and communication solutions are discussed herein. Some embodiments of the present inventive concept use the capabilities of all these technologies to create a robust RTLS tracking solution that includes mobile-mounted location devices 112. Embodiments discussed herein may be very valuable for yard management and asset management where the tracked assets are mobile and can cover large areas both outside and/or underground and/or large indoor spaces.

Referring again to FIG. 1, the real-time location tracking system 100 uses location devices, both stationary 111 and also mobile units 112, attached to assets/vehicles, trackable devices (tags) 115, a data analysis tool (communication system) 101, and a user interface 107 to create a mobile, dynamic tracking area or mesh. As used herein, a “mesh” refers to a system of location devices that can determine the location of tags and location devices within an defines area/environment. In embodiments illustrated in FIG. 1, tracking devices 115 are attached to some vehicles 105 in a vehicle yard. Both stationary 111 and mobile location devices 112 collect raw location data from the tracking devices 115 to determine location. Raw location data could be in the form of any one of the following: received signal strength of a message, arrival time, angle-of-arrival, time-of-flight and the like. Location devices which are stationary 111 may be attached to, for example, poles or exterior walls of a building 104. Such a location device is discussed, for example, in U.S. Pat. No. 10,462,762 entitled Methods for synchronizing multiple devices and determining location based on the synchronized devices and United States Patent Publication No. 2018/0294565 entitled Ultra-Wideband (UWB) Antennas and Related Enclosures for the UWB Antenna, the disclosures of which are incorporated herein by reference as if set forth in their entirety. These location devices can identify location of not only mobile location devices but also trackable tags which are attached to nearby vehicles.

As illustrated, multiple vehicles 105 are outfitted with mobile location devices 112. These mobile location devices 112 can sense the location of UWB trackable devices (tag) 115 or location devices 111/112 that are nearby. When the vehicle mounted with a location device is moving it can sense UWB tracking devices (tag) 115 and location devices 111/112 as it passes in their vicinity.

For the location devices 111 attached to the exterior walls of the building 104, collected location data may be shared with a server 103 either over a wired connection or wirelessly, and mobile location devices may communicate data just wirelessly. Data can be shared over a wired connection using, for example, a USB cable, a PoE ethernet cable or other similar means. For the location devices attached to a mobile vehicle, the collected location data may be shared with the same server 103 wirelessly. Bluetooth, Wi-Fi, LoRa, and other similar technologies are all applicable methods to share that data wirelessly.

In some embodiments, the location data may be processed within the server 103 (data processor 2100) and then shared with users through a user interface, for example, display 107) and/or shared with other systems. In some embodiments, the software interface could be an application programming interface (API), shared through a common database, or visualized directly through a Graphical User Interface (GUI), so that the user can gain insight in the positions of vehicles in the area and/or make decisions based on that information.

As discussed above, embodiments of the present inventive concept may be used in combination with any mobile vehicle/asset and vehicle/asset is broadly defined to include, for example, cars, trucks, buses, trains, boats, scooters, bicycles, animals, livestock, and any other moveable non-affixed object.

In some embodiments, the tags 115 may be powered via a battery, for example, a CR2032 battery, and to conserve power, these tags 115 may go into a low power state, effectively sleeping most of the time. Furthermore, in some embodiments, tags 115 can have an incorporated motion sensor that causes the tag to “wake up” momentarily and ping, i.e., transmit a short message, when moved.

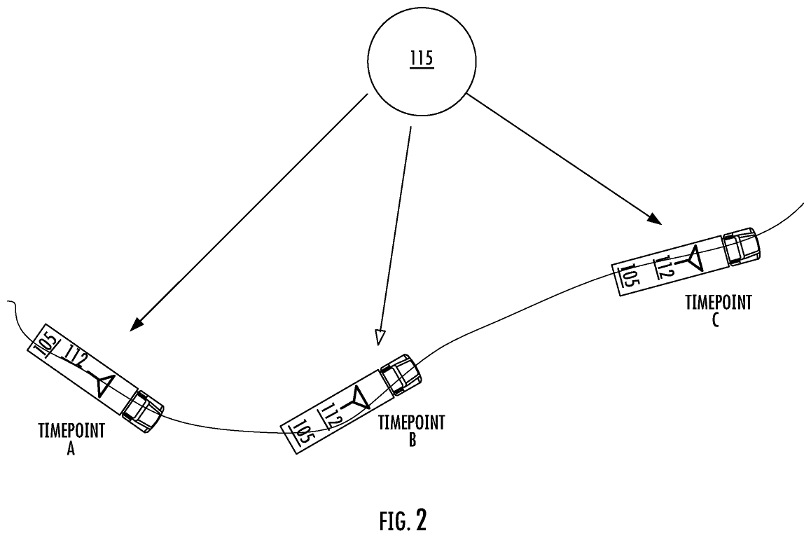

Referring now to FIG. 2, a diagram illustrating a system including a single mobile location device 112 attached to a moving asset (truck 105) that locates a tag 115 while the truck is in motion in accordance with some embodiments of the present inventive concept will be discussed. Generally, more than one location device 112/111 is used in order to locate a tagged asset 115. Using raw location data as received by multiple, spatially separated stationary location devices, the tracking system can calculate the location of the tags provided the location of the stationary location devices are known. If the location device is mobile, however, some embodiments of the present inventive concept may use a single location device to determine the location of a tagged asset.

As illustrated in FIG. 2, a single vehicle 105 is mounted with a mobile UWB location device 112. The vehicle 105 is in motion and passes in RF range of the tag 115 and can receive the tag's RF message. As the vehicle 105 passes the tag 115, it records, for example, multiple time-of-flight measurements at different points in time. Though in this example, time of flight measurements are used, other raw location data could also be captured without departing from the scope of the present inventive concept. In FIG. 2, three timepoints, A, B, and C, are noted. These three measurements are distinct, and, using them, the system determines the relative location of the tag 115.

In some embodiments, nearby location devices can track the movement of the vehicle 105 to determine its pathway. Once the pathway is defined, the relative location can be mapped to the vehicle's pathway and the absolute position of the tag 115 can be determined.

In further embodiments, cameras, a pre-defined driving route, and other means can be used to determine the pathway of the vehicle so that the tag's absolute location can be found.

The inverse of this example can also be applied. In these embodiments the vehicle 105 may be fixed, but the tag 115 may be in motion. In addition to the RF transceiver for tracking, the tag 115 may also include a means to determine relative location to itself over time. For example, an IMU (discussed further here) may be integrated into the tag 115 that allows the tag to determine relative location to itself over a period of time. While the tag 115 transmits a ping for location purposes, it could also pass along the IMU data, either in raw or processed form. The location engine on the server 103 (FIG. 1) then uses the tag's IMU data along with the measured distances from the tag and the stationary location device to determine the tag's location and trajectory over time.

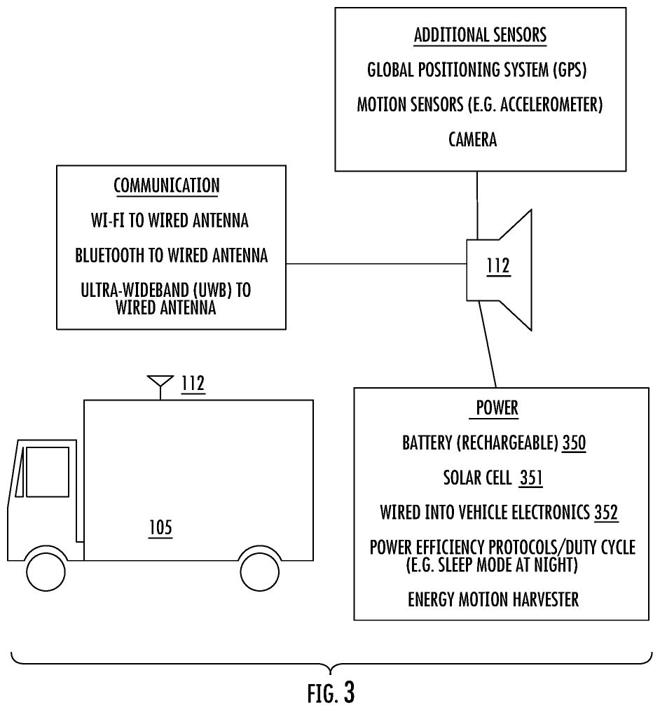

Referring now to FIG. 3, a diagram illustrating a location device 112 with potential adaptions to operate effectively when mounted to a mobile vehicle in accordance with some embodiments of the present inventive concept will be discussed. While a mobile vehicle mounted location device shares many requirements for function with a stationary location device, it does have some specific challenges for successful operations. FIG. 3 illustrates some specific required and optional features that allow optimal operation of the mobile vehicle mounted location device 112 in various environments. It will be understood that the features illustrated and discussed with respect to FIG. 3 may not all be included in every location device 112 without departing from the scope of the present inventive concept. All of the features illustrated are discussed below.

For the tracking system in accordance with embodiments herein to function properly, each location device 112 is powered and has a means to communicate with the system to determine location. A mobile location device 112 generally requires additional powering/recharging solutions and additional sensors to assist with ensuring consistent location information even when the location device temporarily loses its connection with the system during movement or when only a few location devices are present. The boxes in FIG. 3 briefly summarize requirements for some embodiments. Each of these will be discussed further in the following figures. For example, various power solutions include power via rechargeable battery 350, solar cell 351, being directly wired 352 into the vehicle's electrical power system, implementing power efficiency protocols/duty cycles such as sleep mode, using an energy motion harvester and the like. Additional sensors that may be associated with a location device may include a global positioning sensor (GPS), an IMU, camera/LiDAR systems and the like to assist with location determination. Finally, the location devices may include a communication component, such as communication via Wi-Fi, Bluetooth, LoRa, UWB or other means. All these adaptations are discussed further below.

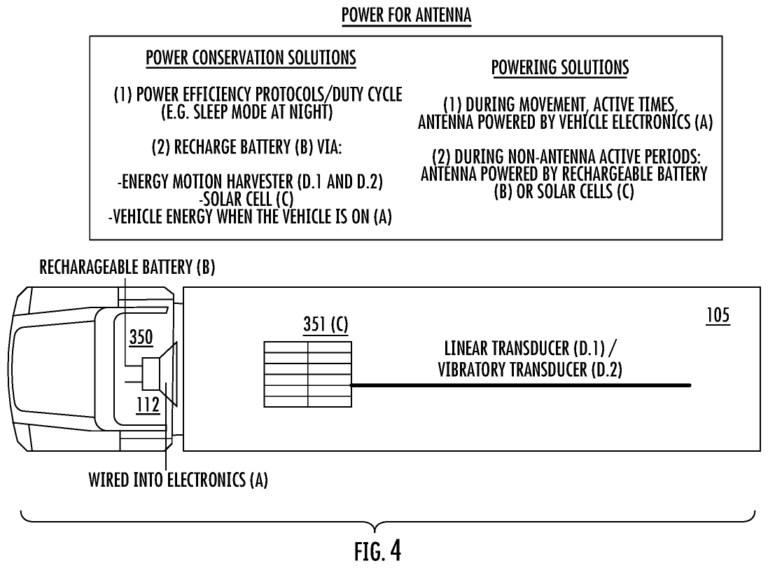

Referring now to FIG. 4, a diagram illustrating various embodiments of providing power to a mobile location device in accordance with some embodiments of the present inventive concept will be discussed. A major challenge for powering a location device 112 affixed to a mobile asset 105 as illustrated in FIG. 4 is ensuring power is adequate for proper functioning when the asset is in motion, when the vehicle is on and idling, when the vehicle is off, and when it is off for extended periods of time. Whether the vehicles rest indoors or outside can also factor into the powering needs thereof.

As illustrated in FIG. 4, the asset/truck 105 is illustrated including many of the various examples discussed above with respect to powering solutions for the mobile location device 112. For example, the truck 105 includes a solar cell 351, both linear (760—FIG. 7) and vibratory (761) transducers, a rechargeable battery 350 and a direct wire into the electronics of the truck 105. Thus, power conservation solutions may include power efficiency protocols/duty cycle (e.g. sleep mode at night), rechargeable batteries that can be recharged using an energy Motion Harvester (d.1 and d.2); a solar cell or a vehicle energy when the vehicle is on. Furthermore, powering solutions may include powering the antenna using the vehicle electronics when the vehicle is in motion and using the battery or solar cells when the vehicle is not in motion.

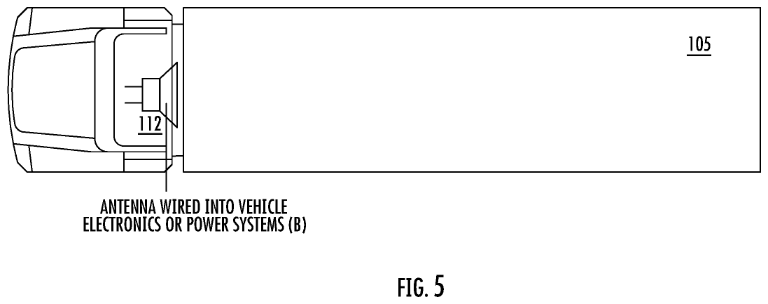

In particular, FIG. 5 is a diagram illustrating specifically how to power the location device 112 when the vehicle is on in accordance with some embodiments of the present inventive concept. For a vehicle 105 that is on and has an accessible electrical power system, the mobile location device can easily be powered by the vehicle itself. This applies to vehicles such as cars, trucks, trains, and airplanes among others. As shown in FIG. 5, the vehicle-mounted location device is wired into the truck's electrical power system supplying it consistently with sufficient power to operate successfully. Likely locations for the tracking device may be on the roof of the vehicle to increase, or possibly maximize, line of site to other devices. In these embodiments, power is wired to the roof of the vehicle. For example, an additional power line could be tapped from the fuse box for this purpose. Alternatively, a shared power line from an existing wire could also be adapted. For example, any system that turns on completely once the vehicle is turned on could be potential candidates for a shared power line. Shared devices may include, for example, light fixtures, internal vehicle monitoring systems, standard power outlets of trucks and cars, and the like.

Furthermore, in addition to accessing power, a mobile location device may also tap into the vehicle diagnostics system of the vehicle. Systems such as the ODB-II provide monitoring information which includes vehicle speed, mileage, emissions, and the like. Some of the diagnostic information can be leveraged to augment location tracking. In these embodiments, the location information can either be sent through the location device directly. Alternatively, if there were a means to communicate directly with the vehicle system itself from the server, the vehicle monitoring data could be accessed without first going through the mobile location device. As an example of how vehicle speed and steering angle could be used to help determine location, consider the scenario where there is a stationary location device with a tag affixed to a vehicle. Over the course of time, the vehicle traces out a path, and the stationary location device takes several distances measurements to the tag. Furthermore, the vehicle provides monitoring data of the speed and steering angle of the vehicle with high fidelity. The speed and steering angle over time traces out a relative path of the vehicle too, and the distance measurements to the stationary location device effectively help determine the vehicle's absolute location. Combining the data, the server location engine calculates the absolute path the vehicle took.

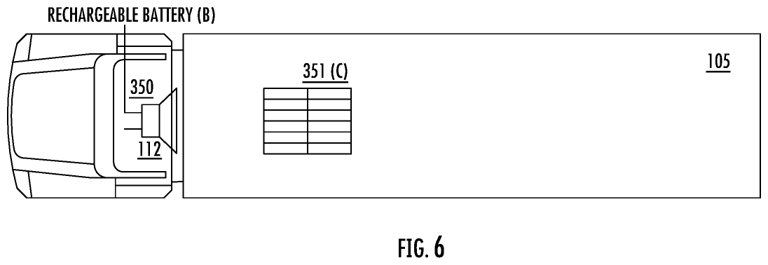

Referring now to FIG. 6, a system for powering a location device 112 on vehicles that lack an electrical power system, such as, bicycles or livestock or simple boats or when the vehicles' power systems are inaccessible or when the vehicles are not actively powered in accordance with some embodiments of the present inventive concept will be discussed. When the vehicle 105 is in the off state, the location device 112 can no longer be powered by the vehicle's electrical power system as discussed above with respect to FIG. 5. As illustrated in FIG. 6, the location device 112 can be powered by a standard battery 350, a rechargeable battery 350, or, if outside during the day, a solar cell 351. These powering solutions can also be used in combination without departing from the scope of the present inventive concept.

Power can be provided to the location device by replacing the device's battery at regular intervals with a new or recharged battery. Alternatively, a charging port, for example, a USB charging port, can be exposed on the location device so that the unit's battery can be charged in place.

A more functional solution is to recharge a battery while it is attached or inside of the location device through the vehicle's electrical power system while the vehicle is on. As discussed above, power can be connected through existing power lines connected to other subsystems of the vehicle or through a new power cable drawn from the fuse box where power is distributed throughout the vehicle.

If the location device is outside during daylight hours, a solar cell 351 can be used to recharge the battery. This is discussed further below with respect to FIG. 7 directed to recharging a battery. A solar cell 351 can also be used to recharge a battery for a vehicle that lacks an electrical power system such as a bicycle, small boat, or other non-motorized vehicle.

For a vehicle mounted mobile location device 112, the infrastructure required to recharge a battery using a plug-in system would likely counteract the benefits of this solution. In the situation where a fleet of electric vehicles (electric cars, golf carts, etc.) is used, the battery could be charged along with the vehicle by wiring into the vehicle's electrical power system.

To further lengthen the time between required recharges, the system may include some intelligence for efficiency protocols and power cycles to conserve battery energy especially when the vehicle and/or yard fleet is at rest. This is especially important for vehicles that may be turned off for long periods of time such as over a holiday.

In some embodiments, power limited location devices could have the ability to “sleep” during low usage time such as at night or over the weekend. With further intelligence, the system could estimate when a mobile object is moving in the area and notify the nearby location devices to “wake up” so they are prepared to track locations of nearby moving vehicles. A sleeping device could wake up periodically to listen for a wake up signal. If no wake up signal is received, it goes back to sleep. Alternatively, or in addition to, if it were known when a device needed to wake up again, say for example, in 3 days time, it could be configured a priori to wake up at that time whether or not it received a wake up command.

In some embodiments, the location device could be outfitted with a motion sensor so that it stays “asleep” until it or neighboring vehicles move.

In further embodiments, the system could determine the battery levels of location devices and the optimal number of location devices to track objects across the area. Based on those two pieces of information, the system could put location devices to “sleep” or “wake up” to maintain functionality of the tracking system but minimize power use and/or reduce the need to change or charge batteries.

Mobile/stationary location devices that are power limited, would need to be more intelligent about when to turn on and communicate. It will be understood that the examples discussed above are provided as examples only, but other embodiments are possible as well. For example, the entire mesh could synchronize with itself, such that all the devices wake up and go to sleep at the same time. For instance, the location devices could have an on time duty cycle where turn-on time is 250 ms, but sleep time is 5 seconds. In this way, the system can reduce its power consumption by about 95%, but still effectively stay on throughout the day. The disadvantage is that 95% of the time, pings from tags or location devices may be missed. However, if tag battery is less of a concern, tags could ping more often to be heard by the mesh.

In some embodiments, a mesh may be included where a sparse set of location devices stay on all the time. The remaining location devices turn on in unision at some sort of duty cycle. When a location device hears a ping, the location device that is on constantly tells the tag when the entire mesh is turned on. The tag then synchronizes its pings such that they fall within the on-time of the system. Over time, tags would need time corrections to reduce the likelihood of drifting outside of the on-time of the mesh system. This additional complexity, however, allows the system to capture most pings and offer considerable power savings.

One way tags and location devices distinguish themselves is by their power modes. Tags spend most of their time sleeping: a deep sleep low power mode. They occasionally wake up and chirp out. In some instances, they will wait for a response. After a brief time however, they will again go into a deep sleep mode. Location devices almost always stay awake listening for messages and sending messages to help synchronize clocking and aid in additional mesh behavior. In the cases where the location devices are powered by the vehicle power systems, they can stay awake constantly performing their mesh maintenance duties. However, during periods when the vehicle is parked or dormant for long periods of time, the power from the vehicle power system to the location device may be cut off. In this circumstance, the location device relies on a battery. In these instances, where there is a necessity to conserve power, the location device may need to behave more like a tag. Instead of fully participating in the mesh activities (i.e. clock synchronization, mesh maintenance etc.), it may simply revert to a deep sleep mode and occasionally wake up to send out a ping and wait for a response. In the “tag mode,” the location device generally cannot aid in determining the location of other tags/location devices, but instead relies on more fully powered location devices to determine its own location.

Referring now to FIG. 7, a diagram illustrating recharging a device battery when in motion in accordance with some embodiments of the present inventive concept will be discussed. As discussed above with respect to FIG. 6, the UWB location device on a vehicle needs to be powered even when the vehicle is off. Some embodiments provide power through a rechargeable battery that is recharged via the vehicle's own electrical power system. Another means of recharging such a battery is through energy harvesters. Energy harvesters capture energy from movements and/or vibration and translate the mechanical energy into electrical energy that can be stored in a battery. This can be useful for recharging when there is a need to limit the drain on the vehicle's own power.

FIG. 7 illustrates the use of energy harvesters to recharge the battery in accordance with embodiments of the present inventive concept. As illustrated, a linear transducer energy harvester 760 is provided on the top of a vehicle, in this case a truck 105. The linear transducer energy harvester 760 captures the energy as the vehicle starts and stops and converts the energy into electricity. A rod moves back and forth with every acceleration and deceleration and turns that energy into electricity that can be transmitted to a battery. The electricity can move down a wire to the battery. FIG. 7 also illustrates a vibratory transducers 761 on the top of the vehicle. A vibratory transducer 761 can be shaken by motion, in this case the motion of the vehicle 105 or vibration of the engine. The movement of the transducer 761 is again converted into electricity that can be carried by wire to a battery. These solutions are attractive in scenarios where limiting the drain on vehicle power usage is desired.

Referring now to FIG. 8, a diagram illustrating sensors for a mobile location device in accordance with some embodiments of the present inventive concept will be discussed. Further to the sensors discussed above with respect to FIG. 3, as illustrated in FIG. 8, sensors 870 can be added to a location device to enhance mobile tracking system functionality. Sensors 870 may include, for example, a Camera or LiDAR system, geolocation sensors (ex. GPS), accelerometers, gyros, magnetometers, altimeters, or in general, IMUs. The use of these sensors in a location tracking system will be described in further detail below.

Appropriate sensors may be affixed to the same device along with the UWB sensor and other components required for successful operation. As previously discussed, IMU sensors can augment location determination by correlating the motion of the location device/tag with the raw location data pings. Camera and LiDAR (image sensors) data can be used in recognizing objects within the field of view to help triangulate location of the tags. These image sensors can either locate moving vehicles to determine those vehicle locations, or if the image sensors are affixed to a moving vehicle itself, they can help determine the location of the vehicle by recognizing stationary objects within the field of view. Further, text within the image sensors field of view could be captured and read through OCR further aiding in the identification and localization of objects within environment.

Geolocation sensors may include solutions such as GPS, Glonass, and Galileo. All of these are satellite based geolocation solutions. In some examples, GPS is used as an example satellite geolocation solution, but it should be noted that other geolocation solutions can also be used without departing from the scope of the present inventive concept.

Satellite Geolocation solutions provide good location accuracy outdoors and depending on the technology (i.e. differential GPS), accuracy could be within centimeters or millimeters. Disadvantages include power consumption, time to lock, and poorer accuracy in urban canyon areas due to satellite occlusion. GPS sensors complement the location tracking solution in areas where the mesh is out of range. Likewise, when GPS receptivity is poor, a mesh can be set up to compensate, accordingly.

Referring now to FIG. 9, a system illustrating the addition of inertial measurement unit (IMU) sensor(s) 114 to improve the functionality of a location device affixed to a mobile vehicle in accordance with some embodiments of the present inventive concept will be discussed. A major challenge for a tracking solution that relies on location devices that are mounted to vehicles is that when the vehicle is in motion, the location device 112 is also moving. At these times, the location device 112 may temporarily lose connection with other location devices in the system as shown in FIG. 9 and require another method to estimate position until the location device can reconnect to a mesh. When a mobile location device is out of range from the mesh, the location device can still collect raw location data of nearby tags and other location devices. Though the mesh alone cannot be used to fully determine location, a location device that includes an IMU 114 can help determine its own location and consequently aid in determining the location of surrounding tags as well.

In particular, IMUS 114 that include some combination of accelerometers, gyroscopes, and/or magnetometers can estimate the location device's specific acceleration, angular rate, direction, speed, and sometimes orientation. By knowing the original position (vehicle starting point) and adding direction and likely speed, the system can use, for example, dead reckoning or other algorithms, to calculate the vehicle's likely path until the location device can reconnect as shown in FIG. 9. In detail, the vehicle 105 loses connection during the drive and then reconnects to the UWB path at the end. This allows the location device to provide accurate tracking information throughout its movement period while within the mesh area. Occasional reception of raw location data from the mesh can help eliminate location drift caused by the exclusive use of IMU to determine location.

Other means exist for dead reckoning of a vehicle path as well. For example, knowing the speed of the vehicle and the angle of the steering wheel allows one to determine the path a vehicle follows. Vehicle speed can be measured by measuring tire rotations, for example. In some vehicles, such data is made available through a standard vehicle monitoring interface (e.g. ODB-II) as discussed above. The tracking system could either directly access this information, through existing wireless communications of the vehicle, or the mobile location device could interface to the monitoring system of the vehicle and extract the information.

Whether by IMU 114 or through steering angle/wheel speed, the system can momentarily estimate path in the absence of other data, and occasionally, the path can be corrected to prevent drift. Such processing may be done on the mobile tracking device directly, or alternatively, the dead reckoning data (i.e. IMU or steering/wheel speed) could be sent directly to the location server to be integrated into a more holistic location tracking solution that takes into account all available raw location data.

In some embodiments illustrated in FIG. 9, the IMU 114 that can measure acceleration and angular velocity is used to estimate speed and direction. This IMU 114 would likely contain an accelerometer and gyroscope to determine respectively speed and the relative heading of the device. Because the location device 112 is affixed to a moving vehicle 105 this would represent the speed and heading of the vehicle as well. The IMU connected to the location device can collect this information at all times. When the location device senses it has lost connection to the mesh it can specify that as the beginning of the IMU-defined-path. When the location device senses it has reconnected to the mesh, it can record that time as the end of the IMU-defined-path. During this IMU-defined-path period, the relative distance or position information of any nearby tags and/or location devices can be recorded as well. At reconnection, the IMU generated data can be shared with the system. The system can use the position information generated via UWB at the beginning and end of the IMU-defined-path along with the acceleration and angular movement generated via the IMU during the IMU-defined-path to determine the location device's position over the entire time period. The relative distance information it collected from nearby tags and location devices while on the IMU-defined-path can then be matched to true position points for the whole mesh. In this way, the system maintains accuracy even when one or more location devices are temporarily disconnected while moving.

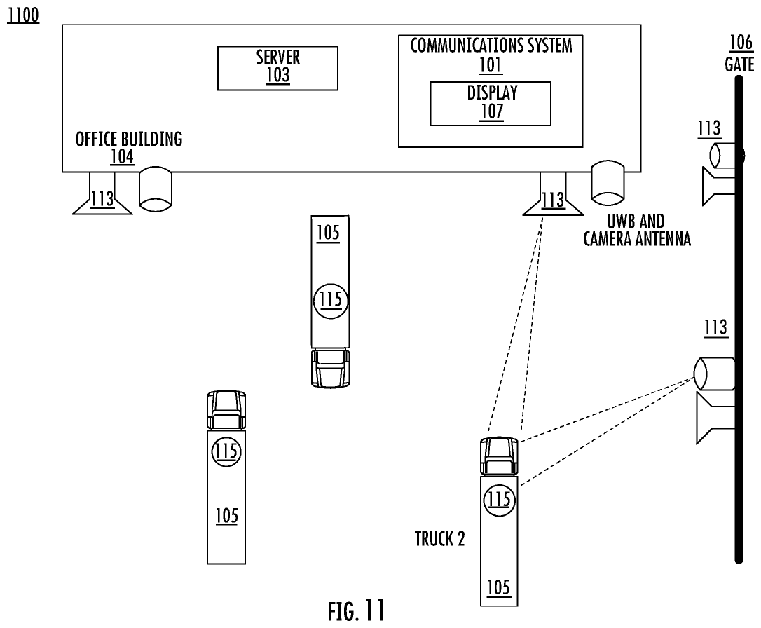

Referring now to FIG. 10, a diagram illustrating use of IMUs in combination with a single location device to determine location accurately in accordance with some embodiments of the present inventive concept will be discussed. While UWB can determine distance accurately between two objects, multiple location devices are generally required to determine position coordinates in 2-D or 3-D space. As discussed in, for example, in U.S. Pat. No. 10,462,762 entitled Methods for Synchronizing Multiple Devices and Determining Location Based on the Synchronized (the entire contents of which is hereby incorporated herein by reference), multiple location devices combine raw location data to measure the location of a tag in 2D or 3D space.

While location devices that are in motion complicate the calculation process, they also offer the opportunity to determine position coordinates with only one location device and one tag. This applies to a single location device using IMU as well when the location device is in motion.

As illustrated in FIG. 10, a vehicle 105 is in motion, and its vehicle location device 112 has lost connection to other location devices. With that information, the system has determined the vehicle is on an IMU-defined-path. While on the IMU-defined-path, the moving location device 112 could receive a signal via UWB that a tag 115 is in the area. In this scenario, there are no other location devices in the area to collect distance data on the tag 115.

While moving, the device would collect the distance data of the tag and the associated timestamp of the received data. As the location device moved along its path, it would receive the tag distance data at multiple time points, timepoints A, B and C. When reconnected to the system, the system could determine the position of the moving vehicle along with IMU-defined-path based on acceleration and angular data calculated by the IMU 114.

Then, by combining three or more distance measurements between the tag 115 and the moving location device and mapping those distances to the vehicle's position at specific time points along the IMU-defined-path, the system can determine the coordinate position of the tag. The system can collect this position based on data using only one location device because the device is moving from one point to another and collecting distance data from those different places.

If the tag is also in motion, the system can use more than three distance measurements collected by the moving vehicle on an IMU-defined path to determine the tag's likely path. If the tag enters the range of other location devices as it moves, the system can further refine the position of the tag using data from multiple location devices.

Additional logic can be applied in the algorithms of the system to flag if a tag is likely non-stationary and alert the system to use more distance measurements. With that alert, the system can use multiple distance measurements until it generates the most likely path for the moving tag.

Additionally, more sophisticated logic regarding motion of tags and vehicles can also be used. Comparing relative position data among the location devices and tags may help the system leverage other location devices to determine and verify the tag's movement and position. For example, if the tag's time-of-flight measurements to a vehicle become longer than the distance the vehicle traveled away from an earlier tag location, that is an indication the tag is moving in the opposite direction from the vehicle. The system can then look for location devices positioned in the direction the tag is moving and check if those location devices receive the tag's signal. This would verify that the tag is moving in that expected direction.

Combining IMU data with distance data from different time points is very valuable when a vehicle is moving through an area with a sparse number of location devices, for example, when a yard is mostly empty of vehicles, when it is moving at the periphery of the mesh area, or other similar low-location device scenarios.

Referring now to FIG. 11, a diagram illustrating the use of combined camera-UWB location devices to assist the system with determining locations in accordance with some embodiments of the present inventive concept will be discussed. An additional sensor tools for a location device could be an optical camera and/or a LiDAR sensor, otherwise referred to herein as “image sensors.” These image sensors may significantly enhance the location accuracy of a tracking system especially during times of low occupancy. As used herein, “cameras” refer to any visually sensing device including optical cameras, LiDAR, motion sensors. In an open area, such as a mostly empty yard, cameras have the ability to see across large distances to identify vehicles and other items.

As illustrated in FIG. 11, a yard 1100 has only a few remaining vehicles 105 to track, and there are an insufficient number of vehicles carrying location devices available to maintain a robust tracking mesh. In the illustrated embodiments, all the vehicles with location devices have left the yard and the remaining vehicles are outfitted with simple tags. In FIG. 11, the system is determining the position of “truck 2.” There are stationary UWB location devices positioned on building 104, gates 106, and the like on the periphery of the yard. The stationary location devices 113 have been fitted with cameras as shown. “Truck 2” is out of the UWB sensor's range, but each camera using vision object recognition can visually identify that a truck is present.

In some embodiments, if the orientation of each camera is known, the visualization data of the truck from the two cameras can be overlaid to determine the likely position of the vehicle through trilateration. In some embodiments, if the system knows the likely size of the truck at different distances, the system can determine the likely distance to the truck from a single camera. If distance data from more than one camera is combined, the system can calculate likely position. Furthermore, if the system has a map of the yard with likely resting positions, such as parking spots, it can map that estimated position to parking spots in the area to refine position.

With further visual cues, such as color, license plate numbers, vehicle number, and other markers, the camera can determine which vehicle it sees. For example, the software could use basic optical character recognition tools to recognize the license plate number of the truck or other writing on the side of the truck. If “truck 2” is linked to its license plate number or other defining features in the system, the camera can verify the position of “truck 2” specifically. This is much more meaningful than just knowing a truck is in that position.

For a parked vehicle, the system can leverage data collected when more location devices were present. If in the morning when many vehicles are in the yard, the system determined “truck 2” has parked in spot X, later when the yard is less populated the cameras can verify that “truck 2” remains in spot X. If images of that area change or show movement, the camera mounted location device can alert the system to seek the pathway or new position of “truck 2”. One possible method for the camera to sense movement could include detecting a change in the images of video frames indicating motion occurred. Other methods could include the use of motion sensors, or lastly, vibration sensors or IMUs of the trucks themselves could notify the system of movement.

When vehicles are in motion, cameras can assist with the overall location accuracy of the system. For example, the camera generated data can assist with location determination for vehicle-mounted location devices that may be temporarily disconnected from the system. Camera sensors can recognize landmarks, building outlines, and other vehicles as a means to create identifiable locations for trilateration. This should help the system maintain functionality even at low volume. Alternatively, the camera-based data could be combined with IMU generated data to improve the accuracy of the IMU-defined-path as discussed earlier.

Due to the ability of cameras to identify vehicles using visual cues such as shape, size, or even license plate numbers (via optical character recognition), cameras have the ability to not only recognize types of vehicles but also specific vehicles as well. As discussed in U.S. patent Ser. No. 17/215,888 entitle Integrated Camera and Ultra-Wideband Location Devices and Related Systems (incorporated herein by reference in its entirety) image sensor data can be processed to identify unique attributes of the object that distinguishes itself from other objects. Attributes can include color, shape or type of vehicle, size, license plate number, or even characteristic motion of the vehicle. Even temporal attributes such as number of people or objects loaded in the vehicle may be identified. Armed with such attributes of the vehicle, the tracking system can verify which vehicles are entering and/or exiting a yard, informing whether the vehicles are fully loaded, etc.

Importantly at night, when optical cameras are not as useful, LiDAR can be used in a similar way and the two can be used in combination to improve the accuracy of the system over a twenty-four hour period.

A distinction should be made between optical cameras and Lidar, laser based ranging systems. Optical cameras generally have much higher resolution than scanning LiDAR systems. With the increased resolution, cameras can more easily recognize objects in their field of view. Useful for trilateration, the position in the cameras field of view refers to the angular position where the object sits in reference to the direction of the camera. An angular offset, as referred to herein, of the object would be independent of the distance it would be from the camera itself. LiDAR systems on the other hand are very good at measuring distances, but less good at recognizing objects compared to optical cameras. So while optical cameras can better determine angular offset from the direction of the camera, LiDAR systems are better at measuring distance to the object. Working together the camera and the LiDAR system could provide the data necessary to exactly identify the location of the object by obtaining the angular offset of the optical camera with the distance measurement of the LiDAR.

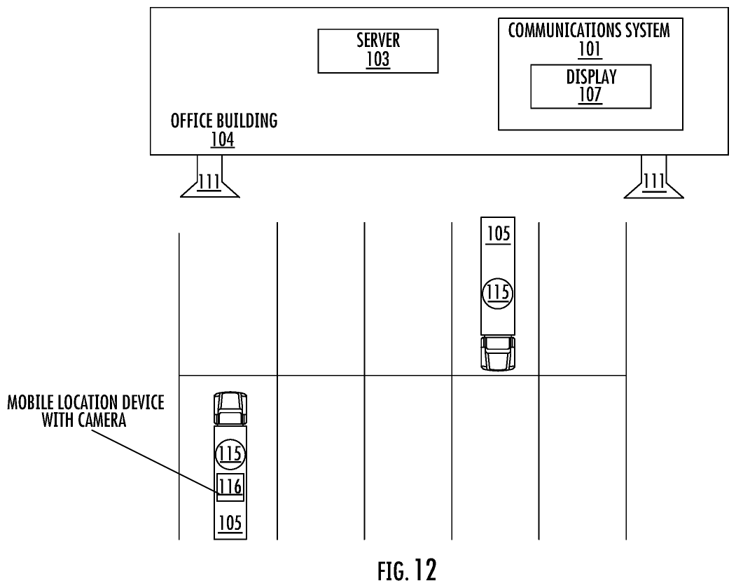

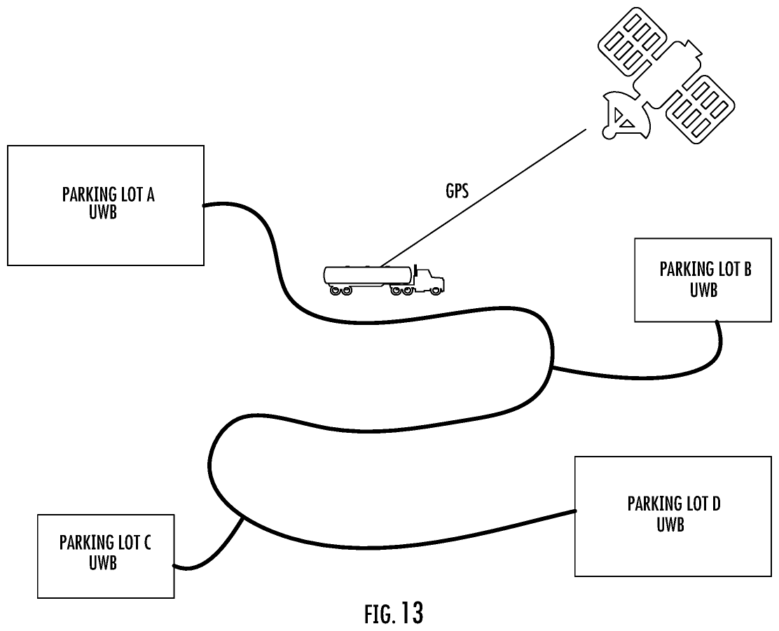

Referring now to FIG. 12, a diagram illustrating use of combined camera-UWB location devices on a vehicle or mobile asset to assist the system with determining location in accordance with some embodiments of the present inventive concept will be discussed. Alternatively, cameras could be mounted on the vehicle along with the mobile location device. This would allow the system to capture visual movement or location information of nearby assets without the use of stationary location devices. Data collected by these mobile location devices could be stored for later or transmitted to the system by cellular, Wi-Fi, Bluetooth, LoRa, or other means. This would be useful to monitor the center of large yards where vehicles may be extremely distant from any stationary location devices.

As illustrated in FIG. 12, the two trucks that remain in the lot are too far away from the stationary location devices 111 attached to the office building 104 for their UWB signals to be detected. The cameras on those stationary location devices are also far enough away that the distance measurements based on images will be inaccurate. However, one truck does have a camera mounted UWB location device 116. The truck is not close enough to the other truck to recognize the signal from its UWB tag, but it is close enough to visually see the truck. With object character recognition it could also determine the license number, the truck number if written on the side, or other markings to record the identity of the truck and likely position.

If the truck can transmit this information via a cellular network or directional antenna, it can keep the system up to date with the location of assets and vehicles far from the stationary location devices.

Referring now to FIG. 13, a diagram illustrating a system utilizing UWB combined with GPS for location tracking in accordance with some embodiments of the present inventive concept will be discussed. As illustrated in FIG. 13, disparate lots are outfitted with UWB mesh systems. Vehicles can be tracked within the lot via a UWB-based system and while traveling between lots by GPS. This GPS data can be stored while outside any mesh or uploaded to a location system shared by the lots (i.e. a company owning multiple lots). When the vehicle arrives at its destination lot, it can connect to the destination lot's mesh and be tracked there. The location data generated by the origin lot, the GPS data while traveling, and at the destination lot can be combined to show all the vehicle's movement. This can be useful in situations where fleets may move between various locations, for example rental cars or trucks.

A vehicle outfitted with a mobile location device or tag at Lot A can be tracked easily within the lot while at Lot A. As the vehicle moves off the lot, it disconnects from the Lot A mesh which the system notes. While the vehicle travels within a city, between cities, it can be tracked via GPS. The vehicle could arrive at one of many lots. The system can even estimate the vehicle's destination lot based on where it is moving by GPS. In these embodiments, the vehicle arrives at Lot D. At arrival, its mobile location device or tag connects to this new mesh at Lot D and can be tracked there. The GPS data can verify where the vehicle originated. In this way the vehicles' owner can track the location of vehicles across many areas using the same consistent system.

One might consider why not use GPS to track the vehicle location exclusively? The argument to include RTLS (UWB) tracking system with GPS include:
1) GPS may not work in the mesh in question. GPS can be unreliable indoors or in urban canyon areas.
2) GPS consumes more power than tag tracking. Judicial use of GPS may be needed in order to stay within a battery budget
3) Tag mesh accuracy could be much higher than GPS such that for applications needing such higher accuracy, the RTLS tracking system accuracy may be preferred.
4) GPS satellite locking can take time whereas tag pings happen instantaneously
   For the reasons cited above, GPS alone may not be sufficient for the application at hand. In fact, GPS could mostly be used during times between lots when exact meter/foot level accuracy is not desired so much as there is a need to know which city or highway it is on.

As a receiver, the GPS determines location of the vehicle, but the data is not yet useful to the mesh locator system. There needs to be a means by which the location data is sent to the server. It has been discussed that location data can be communicated to the server through a wireless solution such as Wi-Fi, Bluetooth, LoRa, cellular, for example. In addition, when such wireless communication options are not available, the mobile location device can also store the GPS data. The GPS data is stored until the vehicle comes within range of a method of communication and consequently using that method, sends data back to the server.

In such a scenario, items and vehicles can be tracked, and a history of their movements can be recorded. It would not necessarily be real-time since GPS data would be saved and later uploaded when possible. This would be very useful for managers of fleets that don't always return to the same lot or may travel throughout the day, such as, rental vehicles, moving vehicles, police vehicles etc.

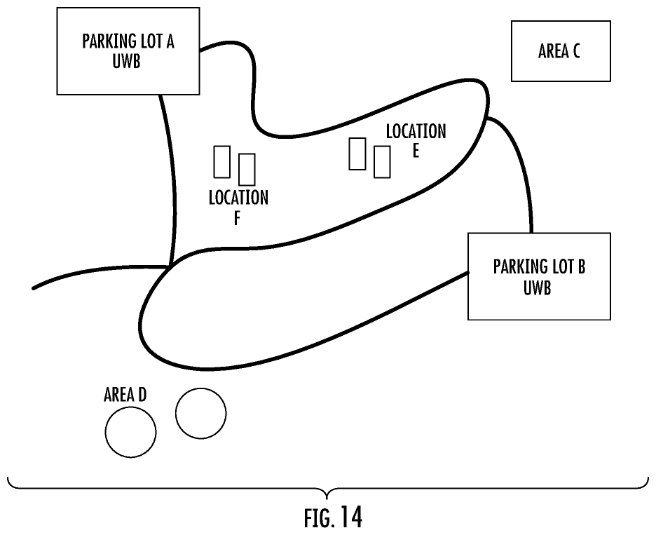

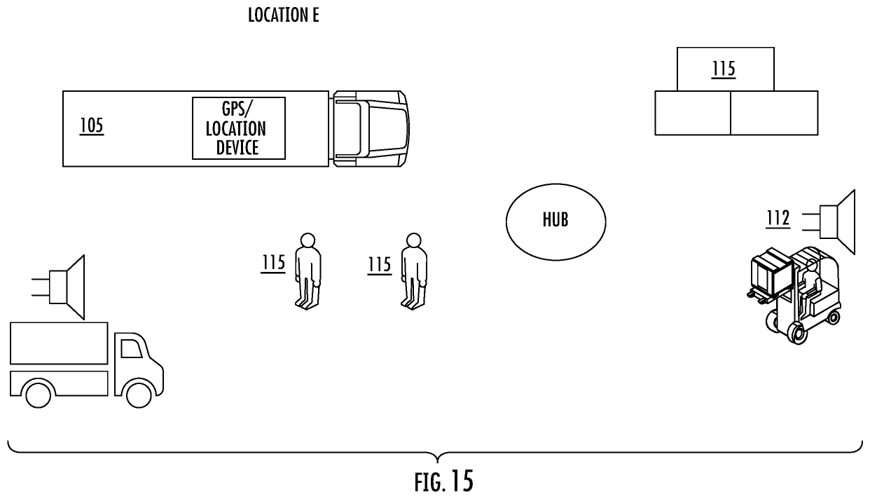

Referring now to FIG. 14, a diagram illustrating a system where mobile location devices combine with GPS and generate absolute location data over a large area in accordance with some embodiments of the present inventive concept will be discussed. For extremely large areas where tracking may be necessary, such as oil refineries, mining areas, farms, etc., there may be a need to track moving vehicles and related personnel or equipment but only in temporary, defined areas. FIG. 14 illustrates a large campus with multiple buildings, parking lots, and a general central area. In this central area, vehicles and/or personnel may work temporarily and need to be tracked, but only for short periods that are in that subarea. It would be cost prohibitive to set up mesh networks across the entire campus, so mobile mesh technology can be combined with GPS to cover these smaller regions.

In FIG. 14, regularly used buildings or facilities are outfitted with stationary and mobile location devices that allow the user to track objects, personnel, and vehicles in those fixed areas at all times. The broad central area, however, does not contain any buildings, fences, or other items where stationary location devices could be mounted. FIG. 14 illustrates a point in time when two groups are working at Regions E and Regions F within the central area. This scenario exemplifies the strategy of tracking in areas of just the regions where tracked items would be most present. These regions could overlap or could be distinct in which case, tracking would be limited to just those areas in the absence of some additional technology such as GPS which could augment tracking outside of the regions. If tags or mobile tracking devices traveled between the regions but were not expected to stay in this non-tracked items for long, IMU's could be employed to perform dead reckoning between the tracking regions.

Referring now to FIG. 15, a diagram illustrating a system where mobile location devices combine with GPS to generate absolute location data over a large area by focusing on small regions in accordance with some embodiments of the present inventive concept will be discussed. If one more closely examines Subarea E of FIG. 14, the vehicles carry mobile location devices that generate relative position data of all nearby tagged assets and location devices. Furthermore, the truck at Subarea E has a mobile location device paired with a GPS sensor. Once that UWB-GPS location device determines its GPS position, the absolute position of all assets within the Subarea E mesh area are defined. There is some means of communicating that position information to a central system, but cellular and other wireless services are possibilities.

Alternatively, cameras/LiDAR systems could be mounted along with the location devices to allow the system to utilize shape and other visual attributes to better recognize landmarks and objects in the environment. This could enhance the system's ability to accurately determine the position of the vehicle with a mobile location device. Such landmark recognition could work even in the absence of GPS.

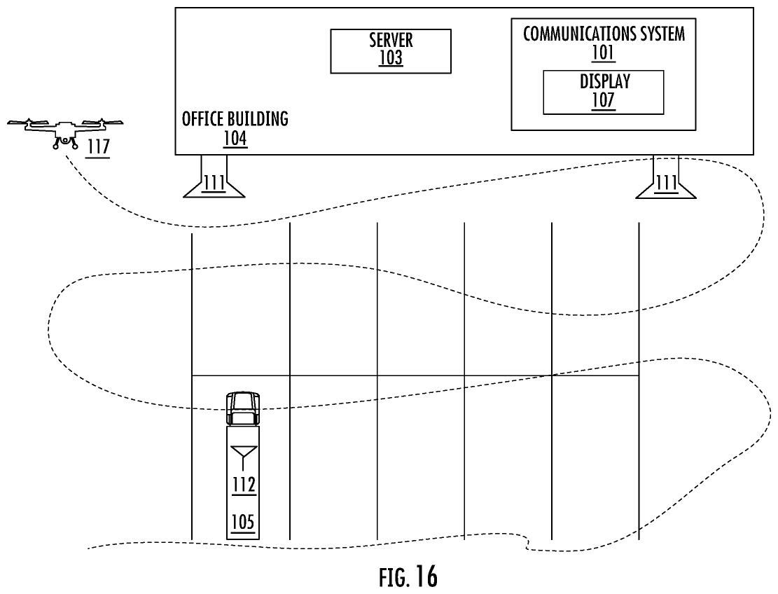

Referring now to FIG. 16, a diagram illustrating the use of a drone 117 outfitted with a mobile location device to locate tagged assets within an area in accordance with some embodiments of the present inventive concept will be discussed. During a low use or period of low availability of location devices, an unmanned aerial vehicle (UAV—e.g. drone) or autonomous ground vehicle (AGV) could make regular sweeps across an area and capture location data of tagged assets within the mesh. This allows the location mesh to stay active even when few mobile location devices are available.

As illustrated in FIG. 16, a large lot contains only one vehicle 105 that is far from any stationary location devices. The vehicle is affixed with a mobile location device 112. This autonomous vehicle (drone 117) with said mobile location device can be used to travel through or above the lot to seek out other location devices or tag signals. In this example, a drone 117 is used. As discussed above, a single mobile location device can determine the relative location of any tagged asset by collecting multiple raw location data measurements at multiple time points.

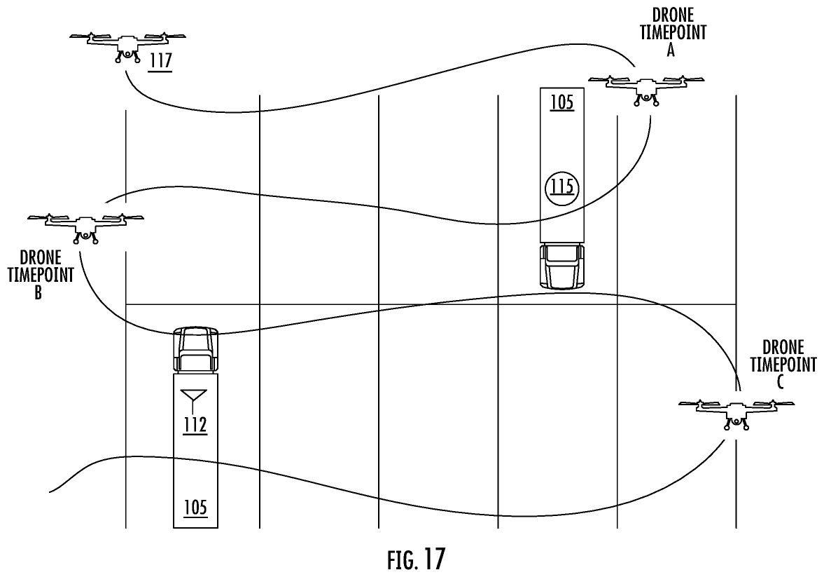

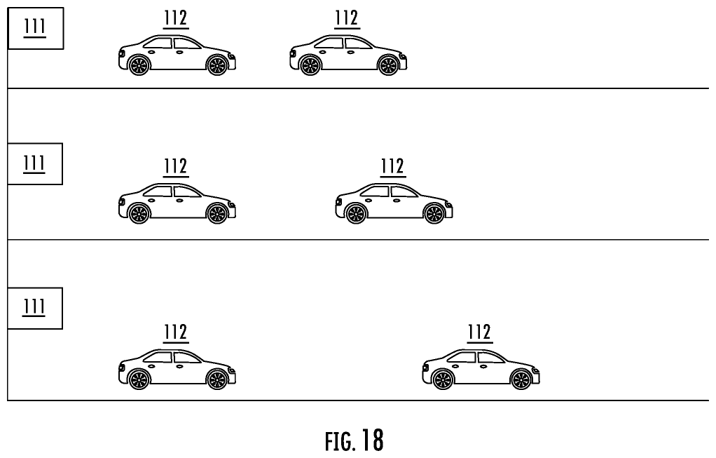

Referring now to FIG. 17, a diagram illustrating how a drone 117 with an affixed location device can act as multiple location devices by capturing location data from multiple positions within an area in accordance with some embodiments of the present inventive concept will be discussed. A single drone can act like multiple location devices in the system by making multiple passes across the area. The drone 117 can collect tag data from multiple positions (A, B, C) as it passes over the defined area. If the drone is aware of its position at each timepoint it can act as an independent location device at each spot, thereby filling in the mesh area where many mobile or stationary location devices are absent. In this way, the drone could capture an accurate map of movement of tagged assets across the area. In this way, the user can know the absolute location of all assets over the entire campus.

Referring again to FIG. 16, a drone 117 is programmed to take a pre-defined path to sweep across the entire area of the yard. In this way the drone location device knows its expected position at any point along the path. As it passes near the single truck, it collects many raw location measurements at specific time points. Such raw location measurements could include Time-of-Flight (ToF), Angle-of-Arrival (AoA), arrival-time, received signal strength (RSS), etc. The system can use that information along with the expected position of the drone at those same time points to calculate the position of the truck. As the drone makes multiple passes over the area, it can further refine the likely position of the vehicle. It can also track the vehicle's location as it moves across the yard. The drone can deliver the information about its own position along with the distance measurements from the location device attached to the truck wirelessly. Alternatively, the drone could internally calculate the location of the location device and send out the location of the location device or tag without having to send out the distance measurements, themselves.

In some embodiments in the path taken by the vehicle, an autonomous ground vehicle or even a vehicle driven by a person along a pre-defined route can be used.

In still other embodiments, multiple drones can be used simultaneously to assess location of tagged assets over an area. Using multiple drones may improve the accuracy, especially when tracking movement, over an extremely large area. The use of multiple drones that can track one another's location could potentially make the use of a predefined path(s) irrelevant. For example, an intelligent/real-time method for determining drone paths to cover the entire area could instead be employed. Alternatively, a method to redirect drones to cover areas that have not been recently covered could be employed as well.

In still further embodiments of path traveling, one or more mobile location devices can be connected to any sort of vehicles in the area. The vehicles do not follow a path intentionally for the mesh, but are used as they would normally be for other applications. As the vehicles move in what could be considered pseudo random motions, the vehicles eventually cover the entire tracking area. As a further embodiment, an autonomous vehicle could be used to deploy to areas that the pseudo random motions of the vehicles do not cover to ensure the entire area is properly tracked.

Time difference of arrival (TDOA) measurements refer to the difference in time between a single pulse received at two separate locations. As another type of raw location measurement, the single vehicle could emulate reception of TDOA signals. To do this, the tag in question would need to ping out twice. Furthermore, the difference in ping transmit times would need to be known with resolution in the picoseconds for centimeter level accuracy. The mobile location device would receive the two transmitted pings and apply an arrival timestamp to each of the two pings. Likewise, the mobile location device would need to have similar picosecond resolution of the timestamp between the two received pings. If the vehicle is moving, the difference between the received timestamps and transmitted timestamps would be different. For example, if the vehicle were moving away from the tag, the received timestamps would be greater than the transmitted timestamps. The emulated TDOA measurement would be the delta of the time between the received timestamps subtracted from the time between the transmitted timestamps. This would provide an effective TDOA relative to the locations of the vehicle at the point the two pings were received by the single mobile tracking device.

Referring now to FIG. 18, a diagram illustrating a mobile location device system in a 3-D multi-floor environment in accordance with some embodiments of the present inventive concept will be discussed. At times, a yard may encompass a 3-D multi-floor space. In these embodiments, the mobile location device-based system incorporates intelligence to determine which floor a vehicle is on. As discussed in, for example, U.S. patent application Ser. No. 17/161,122, Real Time Tracking Systems in Three Dimensions in Multi-Story Structures and Related Methods and Computer Program Products (incorporated herein by reference as if set forth in its entirety), the system can adopt conditional logic to detect floor changes. For example, perhaps there is an elevator or one area in which a vehicle enters a garage and goes up or down a level. If the vehicle never entered those sections, and suddenly appears on a different level, this could be considered an erratic location calculation and hence be thrown out. If on the other hand, the vehicle enters a new level in a specific area on the map which has a ramp, then that new level change could be considered valid. Realistically speaking, floor heights for parking garages are typically between 12 to 20 feet. The tags may be affixed at a single height on each of the vehicles. As such, the calculation engine would need to distinguish which floor the tag vehicle is on based on the height difference between the floors. Considering UWB systems can resolve lateral distances with often times less than 1 foot of accuracy, detecting between floor heights is a comparatively easier task for UWB based RTLS systems to do.

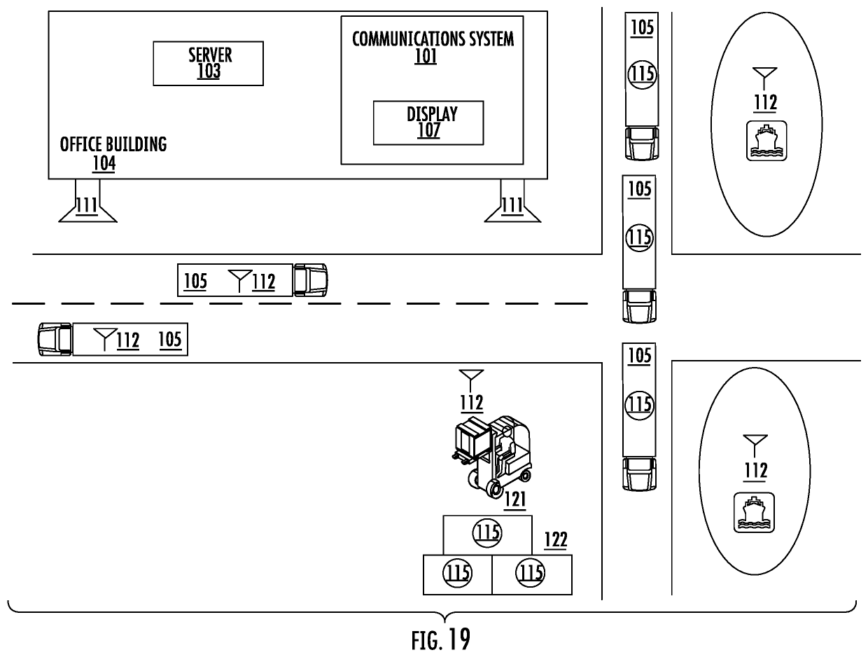

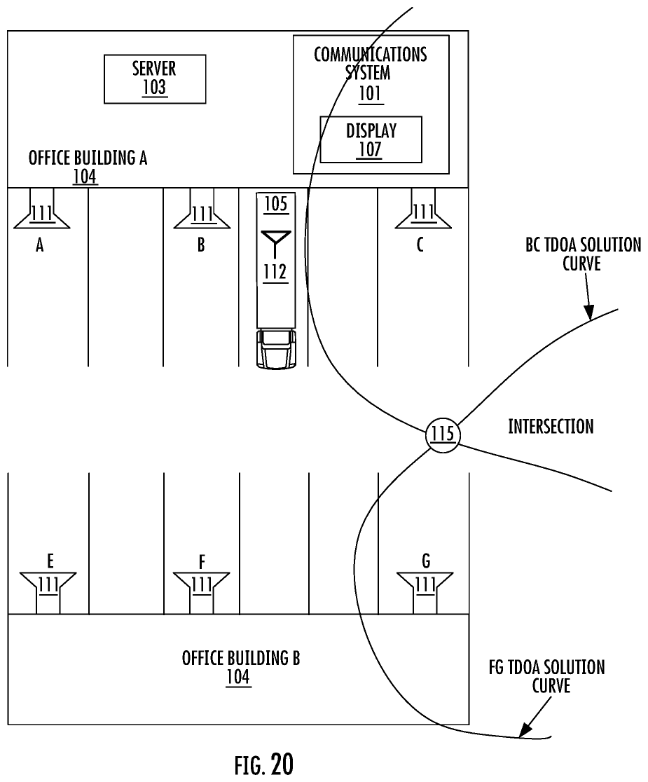

Referring now to FIG. 19, a diagram illustrating a system including a dynamic mesh area where a number of outside vehicles can be integrated into a mesh of stationary and/or local mobile location devices to allow for accurate, precise location of needed assets in accordance with some embodiments of the present inventive concept will be discussed. In some dynamic environments, such as ports, local vehicles, such as forklifts, trucks, etc. may work exclusively at the location while other visiting vehicles, such as, semi-trucks, ships, and even containers, will come in and out of the area. If the visiting vehicles are outfitted with mobile location devices that can connect to the local port mesh at arrival, the system can track where all the location and visiting vehicles and also key assets are located. This would be extremely valuable for outside vehicles to precisely identify the location of containers and cargo that need to be picked up. It would also be helpful for port managers to assess the movement of cargo through the system.

Alternatively, cameras/LiDAR systems could be mounted along with the location devices to allow the system to utilize shape and other visual attributes to better recognize landmarks and objects in the environment. In addition to enhancing the system's ability to accurately determine the location of vehicles or assets, the visual recognition of objects would also enable the system to have a more accurate map of an area in a dynamic space, such as identifying the location of containers as they are being moved through the yard.

FIG. 19 illustrates a busy port area with a number of working vehicles and assets. In FIG. 19, the truck “location device vehicle” originated outside of the port area. As it arrives its location device connects to the port mesh. The system now knows where the vehicle is. If the system knows what kind of cargo the truck is picking up or delivering, it can alert the driver where to go. If the location of types or cargo changes through the day because of the amount present or where it was delivered, the system can alert the driver to the best position based on what is available.

In this case the “location device vehicle” truck is traveling to pick up the small tagged crates 122 by the forklift 121. If the system is aware that the “location device vehicle” truck is picking up those crates, it could alert the nearby forklift 121 and driver to be available and prepare the crates. If the driver of the “location device vehicle” truck has a GUI system to visualize where they needs to go, the driver can arrive at the correct spot easily and be prepared for pick up in a timely manner.

Sharing this kind of real time knowledge across visiting and local vehicles, would save a large amount of time, reduce bottlenecks, and help the port monitor how quickly cargo is moving through the area.

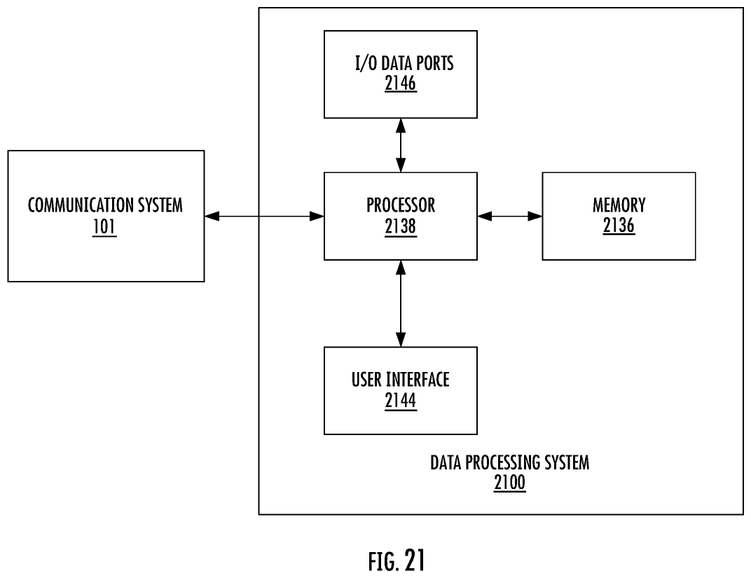

Referring now to FIG. 20, a diagram illustrating a two Mesh Location Calculation in accordance with some embodiments of the present inventive concept will be discussed. In some embodiments, location devices are too far apart to form a single mesh. This may occur in parking or depot areas where a large paved area such as a parking lot or driving lane cannot have any poles or building outposts for affixing stationary location devices onto. Some mesh solutions rely on synchronizing the clock with almost all of the location devices. This is done sending timing messages between the location devices to get them in sync with one another (see previously reference U.S. Pat. No. 10,462,762). However, if distances between location devices are too large, timing messages cannot be sent between them.

As illustrated in FIG. 20, there are two buildings, Building A and Building B where stationary location devices 111 are affixed to the rooftops. On Building A, there are stationary devices A, B, and C. And on Building B, there are stationary devices E, F, and G. In between Buildings A and B, is a trucking loading and driving lane. The distance between the two buildings is larger than the communication distance of the stationary location devices, so instead of having a singular mesh with a clock synchronized among all six stationary location devices, two meshes are formed. The first mesh is formed by synchronizing the location devices A, B, and C, and the second mesh, likewise, is formed by synchronizing the location devices E, F, and G.

In TDOA tracking, a tag 115 pings out a message in which it is received by the tracking devices from each of the two meshes. Consequently, tracking devices regardless of which mesh they are associated with receive the ping message, and each of devices generate an associated arrival timestamp. In this case, a tag (not shown) pings out, and location devices B, C, F, and G receive the ping message and generate an associated arrival timestamp for the message. However, since B, C is in one mesh, and F and G is in another, they are not collectively synchronized and do not have a common time to compare their timestamps. Nonetheless, B and C are in the same mesh, so the arrival times of the tag ping can be compared and a solution space for the tag location can be generated. In this example, the difference in arrival timestamps represents the difference in distance traveled of the ping message from the tag. If we consider the range of points for which there is a constant difference in distance between the A and B, we get the “BC TDOA Solution Curve” as shown in the map. Mathematically speaking this can be represented as a hyperbola but that is not always the case. Likewise, for timestamps from F and G, the solution space is represented by the “FG TDOA Solution Curve.” Following the two curves, there is a single intersection point that satisfies both those solutions, denoted as “intersection” in the figure. Through this method, the tag location is calculated to be at this intersection point.

Though the figure is exemplary in form and shows just two meshes, the general concept is that independent discrete meshes may not be able to determine the location of a tag or other location devices alone, but each one individually can narrow down the solution space. The ultimate solution would then be the intersection of the solution spaces generated from each of the meshes. Meshes could be composed of fixed location devices, mobile location devices, or a combination of the two.

If two meshes are too far apart, tag messages may not reach both meshes, so this approach may not be workable at distances that may be twice the distance that location devices can talk to each other. However, this method has value when meshes are separated by less than twice the maximum RF range where tags in between can still reach the two meshes, but greater than the maximum RF range where below that the two meshes can operate as a single mesh.

Embodiments of the present inventive concept manipulate data to calculate various parameters. Accordingly, some sort of data processing is needed to create and store the data and communication with the communications system 101. FIG. 21 is a block diagram of an example of a data processing system 2100 suitable for use in the systems in accordance with embodiments of the present inventive concept. The data processing may take place in any of the devices (or all of the devices) in the system without departing from the scope of the present inventive concept. As illustrated in FIG. 21, the data processing system 2100 includes a user interface 2144 such as a keyboard, keypad, touchpad, voice activation circuit or the like, I/O data ports 2146 and a memory 2136 that communicates with a processor 2138. The I/O data ports 2146 can be used to transfer information between the data processing system 2100 and another computer system or a network. These components may be conventional components, such as those used in many conventional data processing systems, which may be configured to operate as described herein.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Furthermore, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Furthermore, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A system for tracking movable assets in outdoor or underground environments or large indoor open areas, the system comprising:
at least one stationary location device affixed to an element of the environment;
at least one mobile location device attached to a corresponding moveable asset positioned in the environment;
a plurality of tagged assets in the environment,
wherein the plurality of tagged assets communicate with the at least one stationary location device and the at least one mobile location device; and
wherein information provided by the at least one mobile location device and the at least one stationary device is used to create a trackable area in the environment that enables location of the plurality of tagged assets within the trackable area.

2. The system of claim 1, wherein the at least one mobile location device is powered by one or more of a local battery, a rechargeable battery, a solar cell, a local power system associated with the asset to which the mobile location device is attached, a vibratory energy harvesting transducer and a linear transducer.

3. The system of claim 2, wherein the location device is powered by a rechargeable battery and wherein the rechargeable battery is charged by one of a solar cell, a local power system when the moveable asset is in motion, a vibratory energy harvesting transducer and a linear transducer.

4. The system of claim 1, wherein the at least one mobile location device comprises a communications circuit that enables wireless communication between the at least one mobile location device and one of a remote server and the at least one stationary location device.

5. The system of claim 1, wherein the at least one mobile location device attached to the moveable asset interfaces with a data interface of the moveable asset to obtain data associated with the moveable asset and wherein the data associated with the moveable asset includes one or more of speed, steering wheel position, global positioning system (GPS) information, mileage and emissions.

6. The system of claim 1, wherein the trackable area created by the at least one mobile location device and the at least one stationary device provide a dynamic, mobile mesh that locates tagged assets and/or location device-mounted movable assets as the assets move in and out of the trackable area.

7. The system of claim 6, wherein when the asset associated with the at least one mobile location device is in motion, the system recalculates a position of the at least one mobile location device as it moves with the asset.

8. The system of claim 1, wherein the at least one mobile location device includes an inertial measurement unit (IMU) integrated therein and wherein the IMU determines when the asset associated with the at least one mobile location device is in motion using acceleration, angular velocity, and/or magnetic true North.

9. The system of claim 1, wherein the system uses information provided by the IMU and location data points provided by both stationary and mobile location devices to extrapolate where the movable asset is moving.

10. The system of claim 1, wherein each moveable asset has a mobile location device and/or a tag affixed thereto.

11. The system of claim 1, wherein the moveable asset comprises a bus, a train, a truck, a car, a boat, a person, an animal, a package, a shipped item, a pallet, a golf cart, a forklift and a cart.

12. The system of claim 1, wherein the system uses Wi-Fi, photo transmitters and photodetectors, Bluetooth, LoRa, cellular, radio frequency whose messages can be received with distinct arrival times and/or any technology capable of deriving raw location data between two devices.

13. The system of claim 1, wherein the system further includes one or more cameras that generate data to assist with location calculations.

14. The system of claim 13, wherein the data generated by the one or more cameras assists with identifying vehicles using visual cues, identifying images at night using LiDAR or motion cameras.

15. The system of claim 1, further comprising an autonomous vehicle that provides location information and wherein the information provided by the at least one mobile location device, the at least one stationary device and the autonomous vehicle is used to create a trackable area in the environment that enables location of the plurality of tagged assets within the trackable area.

16. A system for tracking movable assets in outdoor or underground environments, the system comprising:
at least one stationary location device affixed to an element of the environment;
at least one mobile location device attached to a corresponding moveable asset positioned in the environment;
a plurality of tagged assets in the environment,
wherein the at least one mobile location device is powered by one or more of a local battery, a rechargeable battery, a solar cell, a local power system associated with the asset to which the mobile location device is attached, a vibratory energy harvesting transducer and a linear transducer.

17. The system of claim 17, wherein the location device is powered by a rechargeable battery and wherein the rechargeable battery is charged by one of a solar cell, a local power system when the moveable asset is in motion, a vibratory energy harvesting transducer and a linear transducer.

18. The system of claim 17:
wherein the plurality of tagged assets communicate with the at least one stationary location device and the at least one mobile location device; and
wherein the at least one mobile location device and the at least one stationary device create a trackable area in the environment that enables location of the plurality of tagged assets within the trackable area created by the at least one mobile and/or stationary location devices.

19. The system of claim 17, wherein the at least one mobile location device includes at least one of a GPS sensor, a motion sensor and a camera.

20. The system of claim 17, wherein the at least one mobile location device includes a communication circuit that communicates with a remote server or the at least one stationary location device using Wi-fi, Bluetooth, cellular, Bluetooth, LoRa, and/or UWB.
